(19) United States
(12) Patent Application Publication
(10) Pub. No.: US 2008/0114776 A1
(43) Pub. Date: May 15, 2008

(54) Method and system for providing presence information, the presence server thereof

(75) Inventors: Qian Sun, Shenzhen (CN); Jing Lu, Shenzhen (CN); Yang Zhao, Shenzhen (CN)

Correspondence Address: LADAS & PARRY LLP, 26 WEST 61ST STREET, NEW YORK, NY, 10023, US

(73) Assignee: HUAWEI TECHNOLOGIES CO., LTD.

(21) Appl. No.: 12/008,638

(22) Filed: Jan. 11, 2008

Related U.S. Application Data
(63) Continuation-in-part of application No. PCT/CN2006/001302, filed on Jun. 13, 2006.

(30) Foreign Application Priority Data
Jul. 22, 2005 (CN) 200510085286.9

(51) Int. Cl. G06F 17/30

(52) U.S. Cl. 707/10

(57) ABSTRACT

A method for providing presence information is applied to a presence system, that includes a presentity, a presence server and at least one watcher. The method includes that in the presence server setting separately the value corresponding to the watcher's attributes for the same presence information provided by the presentity. The presence server provides the corresponding value of the presence information according to the watcher's attributes. Accordingly, there is also a system for providing presence information and the presence server thereof. The invention can provide the corresponding value of the presence information according to the different watchers.

### CROSS REFERENCE TO RELATED APPLICATIONS

This application is a continuation-in-part of International Application No. PCT/CN2006/001302, filed Jun. 13, 2006, which claims the priority of Chinese Application No. 200510085286.9, filed Jul. 22, 2005, the content of both of which is incorporated herein by reference.

### FIELD OF THE INVENTION

The present invention relates to the field of PRESENCE SERVICE, in particular, to a method and system for providing presence information, and a presence server thereof.

### BACKGROUND OF THE INVENTION

PRESENCE SERVICE is a communication service for collecting and distributing presence information, usually provided together with INSTANT MESSAGE SERVICE at present. For example, in instant communication systems such as MSN and QQ, presence service and instant message service are provided simultaneously. Present information according to the invention refers to generalized presence information, including static information and dynamic information. Users may register some basic personal information (basic information for short) with these communication systems, for example, static information such as nickname, gender, age, e-mail address, region, personal introduction, and provide dynamic information such as online status, mood, activity, position (such information is all so-called presence information). For all the contact persons or buddies of a user, the presence information provided by the user via these communication systems is totally the same.

In the above cases, to prevent others, especially strangers, from seeing some presence information that has been registered, users usually fill in some rough, even false presence information (such as personal contact information or home address). As a result, some familiar contact persons, such as family members, relatives and friends, colleagues, cannot obtain the detailed and real presence information that the user wants to provide to them. Moreover, at present, many instant message users have a plurality of user account identities at the same time, and the presence information registered for each of the user account identities is different from each other. Each of the user account identities may correspond to a different network identity. For example, a user may use a network identity for working contact, and another for chatting, making friends, and so on. But it is inconvenient for a user to register a plurality of user accounts, because a plurality of account identities and passwords need to be memorized. And in use, a plurality of instant message client terminals are required to be started simultaneously in order to respectively log on each user account.

Therefore, it is needed to provide a solution which provides different presence information for a user's different contact persons; for example, taking the address presence information of a user as an example, a rough address presence information value, such as “Shenzhen” may be provided to a stranger, but a detailed address presence information value, such as “HUAWEI BASE F1-07-A077S, Bantian, Longgang District, Shenzhen”, may be provided to familiar contact persons such as colleagues and friends.

In addition, user's state information is also presence information specified in the presence service. The user also wants to display different state information such as offline and online for different contact persons.

Currently, International Standard Organizations, such as IETF and OMA, all have preliminarily drawn and released standard specifications about presence service, respectively. In these specifications, the presence service for collecting and distributing presence information may exist totally independent of instant message service. However, at present, presence service is usually provided together with instant message service. Moreover, a presence service system may be used not only for a natural person (the above mentioned user), but also for a non-natural person. For example, a radio station (non-natural person) may distribute song information being broadcasted to its presence information subscribers. For another example, a presentity of a weather forecast service (non-natural person) may also release weather report to each subscriber. Similarly, a non-natural person presentity also has a need of providing different presence information to different subscribers. For example, presentity of a weather forecast service may also provide weather situation information of different regions to subscribers corresponding to their regions.

It can be seen that at present, for both natural person presentity and non-natural person presentity, it cannot provide different presence information according to different watchers (including the above mentioned contact persons and presence information subscribers, etc).

### SUMMARY OF THE INVENTION

The invention provides a method for providing presence information, so that corresponding values of presence information may be provided according to different watchers.

Correspondingly, the invention further provides a presence server and a system thereof for providing presence information.

The invention puts forward the following technical solutions.

A method for providing presence information used in a presence system including a presentity, a presence server and at least one watcher, includes:

setting values of one piece of presence information provided by a presentity in the presence server corresponding to the watchers' attributes respectively; and

providing a corresponding value of presence information according to a watcher's attribute by the presence server.

The method further includes, before providing the corresponding value of the presence information according to the watcher's attribute, setting a default value of the presence information provided by the presentity in the presence server; and

providing the corresponding value of presence information according to the watcher's attribute includes providing the default value for presence information to a watcher when the presence server cannot obtain a value of the presence information corresponding to the watcher's attribute.

The method further includes, before setting the values of the presence information provided by the presentity in the presence server corresponding to the watchers' attributes respectively, the following processes:

setting, when the presentity receives a subscription request from the watcher, the value of the presence information provided by the presentity corresponding to the watcher's attribute by the presentity; and

sending a corresponding relation between the value set by the presentity and the watchers' attribute, together with a Subscription Permitted Message, to the presence server.

The method further includes, before process setting the value of the presence information provided by the presentity corresponding to the watcher's attribute, the following processes:

setting the value of the presence information provided by the watcher corresponding to the presentity's attribute when the watcher requests subscribing to the presence information of the presentity;

sending a corresponding relation between the value of the presence information set by the watcher and the presentity's attribute, together with a Subscription Request Message, to the presence server;

buffering the corresponding relation between the value of the presence information set by the watcher and the presentity's attribute and forwarding the Subscription Request Message to the presentity by the presence server;

providing corresponding value of the presence information to the presentity by the presence server if the presentity feeds back a Subscription Permitted Message to the presence server in response to the Subscription Request Message received; and

deleting the buffered corresponding relation between the value of the presence information set by the watcher and the presentity's attribute by the presence server if the presentity feeds back a Subscription Rejected Message to the presence server.

Further, setting the values of the presence information provided by the presentity in the presence server corresponding to the watchers' attributes respectively includes establishing an expression of corresponding relations between the watchers' attributes and the values of the presence information in the presence server.

The providing the value of the presence information according to the watcher's attribute includes:

resolving the expression of the corresponding relation according to the watcher's attribute and obtaining corresponding value of the presence information by the presence server; and

providing the corresponding value of the presence information obtained to the watcher.

Further, setting the values of the presence information provided by the presentity in the presence server corresponding to the watchers' attributes respectively includes establishing a mapping relation table between the watchers' attributes and the values of the presence information in a memory of the presence server or a peripheral storage medium; and.

providing the corresponding value of the presence information according to the watcher's attribute includes:

retrieving the mapping relation table according to the watcher's attribute and obtaining corresponding value of presence information by the presence server; and

providing the corresponding value of the presence information obtained to the watcher.

The watcher's attribute is presence information of the watcher; or

information set by the presentity for the watcher; or

a type of the watcher; or

an identification of the watcher; or

a combination of at least two of any types of the presence information of the watcher, the information set by the presentity for the watcher, the type of the watcher and the identification of the watcher.

The presence information of the watcher is one of basic information of the watcher and state information of the watcher. The set information is a group identification of the watcher set by the presentity. The type of the watcher is SUBSCRIBER, or FETCHER.

An embodiment of the invention provides a presence server, including:

a storage unit, for storing values of one piece of presence information provided by a presentity corresponding to watchers' attributes respectively;

a presence information value retrieving unit, for retrieving a corresponding value among the values of the presence information corresponding to the different watchers' attributes respectively stored in the storage unit, according to a watcher's attribute; and

a presence information value providing unit, for providing the corresponding value retrieved by the presence information value retrieving unit to the watcher.

An embodiment of the invention provides a system for providing presence information, including a presentity, a presence server and a watcher.

The presentity is adapted to provide values corresponding to the watchers' attributes respectively for the same presence information to the presence server.

The watcher is adapted to send a subscription request for presence information to the presence server; and

The presence server is adapted to store the values of the presence information corresponding to the different watchers' attributes respectively provided by the presentity, and retrieving a corresponding value among the stored values of the same presence information corresponding to the different watchers' attributes respectively according to an attribute of a watcher and providing the retrieved corresponding value to the watcher when receiving a subscription request for the presence information from the watcher.

Preferably, the presence server includes:

a storage unit, for storing the values of the presence information provided by the presentity corresponding to watchers' attributes respectively;

a presence information value retrieving unit, for retrieving a corresponding value among the values of the presence information corresponding to the different watchers' attributes respectively stored in the storage unit, according to a watcher's attribute; and

a presence information value providing unit, for providing the corresponding value retrieved by the presence information value retrieving unit to the watcher.

Correspondingly, an embodiment of the invention further provides a method for providing presence information, used in a presence system including a presentity, a presence server and at least one watcher, including:

setting corresponding value groups of presence information respectively for different watchers' attributes in the presence server, wherein the value group of presence information comprises values of different presence information provided by the presentity; and

providing a corresponding value group of presence information according to a watcher's attribute by the presence server.

Setting the corresponding value groups for the presence information respectively for the different watchers' attributes in the presence server further includes setting a default value group of presence information in the presence server, wherein the default value group of the presence information comprises default values of different presence information provided by the presentity; and

providing the corresponding value groups of the presence information according to the watcher's attribute further includes providing the default value group of the presence information to the watcher when the presence server cannot obtain the corresponding value group of the presence information.

The watcher's attribute is presence information of the watcher; or

information set by the presentity for the watcher; or

a type of the watcher; or

an identification of the watcher; or

a combination of at least two of any types of the presence information of the watcher, the information set by the presentity for the watcher, the type of the watcher and the identification of the watcher.

An embodiment of the invention provides a presence server, including:

a storage unit, for storing corresponding relations between different watchers' attributes and corresponding value groups of presence information, wherein the value group of presence information comprises values of different presence information provided by a presentity;

a presence information value group retrieving unit, for retrieving a corresponding value group of presence information in the corresponding relations between the different watchers' attributes and the corresponding value groups of presence information stored in the storage unit, according to a watcher' attribute; and

a presence information value group providing unit, for providing the value group of presence information retrieved by the presence information value group retrieving unit to the watcher.

An embodiment of the invention provides a system for providing presence information, including a presentity, a presence server and a watcher.

The presentity is adapted to provide value groups of presence information corresponding to the watchers' attributes to the presence server, wherein the value groups of the presence information comprise corresponding values of different presence information provided by a presentity;

The watcher is adapted to send a subscription request for the presence information to the presence server; and

The presence server is adapted to store corresponding relations between the watchers' attributes and the corresponding value groups of presence information according to the value groups of the presence information which correspond to the watchers' attributes provided by the presentity, and retrieving a corresponding value group of presence information in the stored corresponding relations between the watchers' attributes and the value groups of the presence information according to a watcher's attribute and providing the retrieved corresponding value group to the watcher, when receiving a subscription request for the presence information from the watcher.

Preferably, the presence server includes:

a storage unit, for storing the corresponding relations between the different watchers' attributes and the corresponding value groups of presence information;

a presence information value group retrieving unit, for retrieving the corresponding value group of presence information in the corresponding relations between the different watchers' attributes and the corresponding value groups of presence information stored in the storage unit, according to the watcher's attribute; and

a presence information value group providing unit, for providing the value group of presence information retrieved by the presence information value group retrieving unit to the watcher.

In the embodiments of the invention, the following beneficial effects may be attained.

In the invention, values corresponding to the watchers' attributes are set respectively for the same presence information provided by a presentity in a presence server; then the presence server may provide corresponding values of presence information to a watcher according to the watcher's attributes. Alternatively, by setting corresponding value groups of presence information for different watchers' attributes in a presence server, the value group of presence information including corresponding values of different presence information provided by the presentity, the presence server may provide corresponding value groups of presence information according to the watcher's attributes. Therefore, the presentity may provide corresponding values of presence information according to different watchers, so that a presentity user may provide real and detailed presence information to familiar watcher users and provide rough presence information to strange watcher users; meanwhile, the presentity may provide detailed presence information to subscribers and provide rough presence information to fetchers. As a result, the presentity may provide different presence information according to different watchers, so that the providing mode of the presence information may be more flexible and more convenient.

### BRIEF DESCRIPTION OF THE DRAWINGS

The features and nature of the present invention will become from the detailed description set forth below when taken in conjunction with the drawings in which like reference characters identify correspondingly throughout and wherein:

FIG. 1 is a flow chart showing the main principle of the invention;

FIG. 2 is a schematic diagram showing the processing procedure for a presentity and a client terminal to provide presence information to each other;

FIG. 3 is a block diagram of the first presence server provided according to the invention;

FIG. 4 is a block diagram of the first system for providing presence information provided according to the invention;

FIG. 5 is a flow chart showing another main principle of the invention;

FIG. 6 is a block diagram of the second presence server provided according to the invention; and

FIG. 7 is a block diagram of the second system for providing presence information provided according to the invention.

### DETAILED DESCRIPTION OF THE EMBODIMENTS

A method of providing presence information according to an embodiment of the invention provides a process mode which enables a presentity to provide corresponding values of presence information according to different watchers. The main principle of the invention and embodiments thereof will now be illustrated in detail in conjunction with each of the drawings.

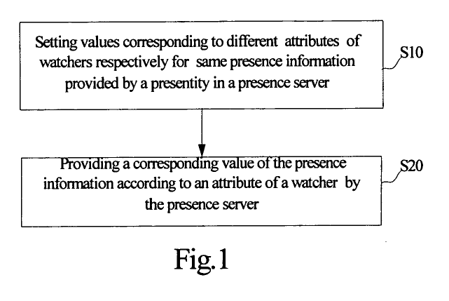

FIG. 1 is a flow chart showing the main implement principle of the invention, which is as follows.

In Block S10, values corresponding to the watchers' attributes are set for one piece of presence information provided by a presentity in a presence server. The presence information includes not only the basic information of a user, for example, static information such as name, age, address and gender, but also the current state information of a user, for example, dynamic information such as online, offline, mood, activity and position. The presence information may also include weather information or broadcast information, etc. According to an embodiment of the present invention, it is possible to set different values corresponding to the watchers' attributes for the same presence information.

In Block S20: the presence server provides a corresponding value for presence information according to a watcher' attribute, in other words, the presence server retrieves and obtains the corresponding value for presence information according to the attribute information of the watcher, then provides the corresponding value for presence information obtained to the watcher.

The presentity may also set a default value for each presence information respectively in the presence server. Thus, when the presence server cannot obtain the corresponding value for presence information according to the watcher's attribute, the presence server may provide the default value for presence information to the watcher.

The above mentioned attribute of the watcher may be presence information provided by a watcher. The presence information provided by the watcher may be the basic information of the watcher (such as the region presence information, gender presence information, age presence information and so on provided by the watcher) The above mentioned attribute of the watcher may also be state information of the watcher (such as online and offline information). The presence information of the watcher is also saved in the presence server. When the presence server provides presence information provided by a presentity to the watcher, the presence server first retrieves and obtains a value for presence information of the watcher, and then provides the corresponding value for presence information provided by the presentity according to the obtained value for presence information of the watcher.

In addition, the watcher's attribute may also be the information set by the presentity for the watcher. The information set by the presentity for the watcher may be group identification information of the watcher set by the presentity, etc.

In addition, the watcher's attribute may also be a type of the watcher. Types of the watcher specified in the standards include subscriber and fetcher. A subscription relation record of the presence information of the presentity is saved in the presence server, and the presence server may know the type of the watcher by retrieving the subscription relation record.

In addition, the watcher's attribute may also be identification information of the watcher, such as the user identification information of the watcher user (i.e., the watcher user ID). In some presence service systems, a mobile station number or an e-mail address is regarded as the watcher user identification.

At the same time, a combination of at least two of any types of the above attribute information such as the presence information provided by the watcher, the information set by the presentity for the watcher, the type of the watcher and the identification of the watcher may also be regarded as the attribute information of a watcher.

In the presence server, the corresponding relations between the values of presence information and the watchers' attributes may be expressed using the following expression.

“attribute 1: value 1 & attribute 2: value 2 . . . default: default value”. “Attribute” may be the presence information of the watcher, the type of the watcher, the information set by the presentity for the watcher, or a combination of the above attributes. Thus, the presence server may resolve the above expression according to the watcher's attribute, so that corresponding value for presence information may be obtained; then, the corresponding value for presence information obtained are provided to the watcher, so that different values of presence information may be provided by the presentity according to different watchers' attributes.

In an embodiment of the invention, in order to provide different values for the same presence information according to different watchers, first of all, display condition information should be set respectively for different values for the same presence information of the presentity; although many pieces of presence information are usually set for a presentity, different values may be set for some pieces of the presence information, and display condition information may be set for each value.

Hereinafter, a client terminal corresponding to the presentity is referred to as a first presence client terminal, and a client terminal corresponding to the watcher is referred to as a second presence client terminal. In fact, the presence service is seldom provided independently. For example, in OMA standards, the presence service is provided as a service function. At present, when a presence service and an instant message service are provided simultaneously, a presence client terminal is also an instant message client terminal. For example, client terminals such as MSN and QQ may receive and send instant messages and release and subscribe to presence information simultaneously. Moreover, the presence service may also be provided together with other services in addition to the instant message service. For example, the presence service may be provided together with a network game service. Thus a network game client terminal is a presence client terminal. Therefore, a presence client terminal mentioned in an embodiment of the invention includes not only pure presence client terminal, but also client terminal integrated with other service client terminal, which may release and subscribe to presence information. Similarly, the presence service system and presence service server mentioned in an embodiment of the invention may also include systems and servers integrated with other services such as instant message service.

The first presence client terminal (i.e., presentity) releases presence information to the presence server. Some pieces of the presence information released may be set with a plurality of values at the same time, and each value corresponds respectively to display condition information related to a watcher. The presence server provides corresponding value for the display presence information according to the obtained display condition information related to the watcher; at least one second presence client terminal (i.e., watcher) subscribes to or obtains the presence information released by the above first presence client terminal, and the presence server sends the corresponding presence information released by the above first presence client terminal to the second presence client terminal.

There are mainly two types of the above watchers depending on whether the watcher is in a buddies list of the presentity: FETCHER and SUBSCRIBER. The presentity also has a blacklist. For the watcher listed in the blacklist of the presentity, offline or close information of the presentity is provided, even though the presentity is actually in online or open status. A fetcher mainly refers to a watcher who has not been authorized to subscribe for the presence information according to the present invention, i.e. the fetcher is not in the buddies list. While a subscriber is a watcher who has been authorized to subscribe for the presence information by the presentity, and usually in the buddies list.

The main implementation process of the method for providing presence information according to an embodiment of the invention is as follows.

The first presence client terminal releases presence information and sets display condition information.

Since the basic presence information of a presentity is usually saved in a presence server during registration, and may also be modified by the presence client terminal as required, the first presence client terminal will release presence information to the presence server when the presence client terminal logs on to the presence system or when change occurs in the presence information such as state information and basic information.

After the first presence client terminal logs on to the presence system, the first presence client terminal may send a request to the presence server for setting the display condition information. The request includes a presence information identification and corresponding display condition. The presence server stores the presence information identification and corresponding display condition information received in a build-in or peripheral storage entity. The presence information identification is the name of the presence information, for distinguishing between different presence information.

For example, it is assumed that the presence information identification released is “address” presence information and two values are set for the address presence information simultaneously, which are “Shenzhen” and “Huawei Technologies, Shenzhen” respectively. The display condition information set corresponding to the two values respectively is “FETCHER” and “SUBSCRIBER”. Thus, corresponding relations between the two values of the address presence information and the corresponding display condition information will be stored in the presence server or a peripheral storage entity of the presence server, i.e., “FETCHER-Shenzhen, SUBSCRIBER—Huawei Technologies, Shenzhen”; and the default address provided is “Shenzhen”. Thus, the address provided by the presence server to a SUBSCRIBER is “Huawei Technologies, Shenzhen”, while the address provided to a FETCHER is “Shenzhen”.

Generally, when a natural person wants to subscribe to presence information of a presentity, he or she needs to be confirmed by the presentity client terminals, thus the user may exercise control on providing more detailed presence information to a subscriber than to a fetcher. However, for a non-natural person, such as a presentity which provides weather forecast service, a subscriber is usually required to pay certain service fee, thus the presence information obtained by a fetcher who does not subscribe to presence information may be somewhat less than the presence information obtained by a subscriber. For example, weather forecast of recent three days may be provided to a subscriber, while daily weather forecast may be provided to a fetcher.

The above mentioned presence server may save the display condition information set together with the presence information; optionally, the display condition information may also be saved in an independent peripheral storage entity of the presence server. Moreover, the display condition information may be stored using an XML file, and may also be stored using database records.

One example in which the display condition information is stored using an XML file is shown below:

<?xml version=“1.0” encoding=“UTF-8”?>
<ruleset>

<rule id=“ck81”>

<address>

<FETCHER>Shenzhen </FETCHER>
<SUBSCRIBER>Huawei Technologies,
Shenzhen</SUBSCRIBER>

</address>
</rule>

</ruleset>

When the display condition information is stored in a peripheral storage entity of the presence server, the presence server may interact with the peripheral storage entity via XCAP (Extensible Markup Language (XML) Configuration Access protocol) protocol, so the display condition information may be set and obtained. Two operations are taken as examples: 1) creation of a display condition information XML file; 2) addition of an item to a display condition information XML file.

1 Creation of a Display Condition Information XML File

PUT
http://xcap.example.com/services/sip:yangzhao@example.com/friends.xml
HTTP/1.1

...

Content-Type: application/xml
Content-Length: (...)
<?xml version=“1.0” encoding=“UTF-8”?>

<ruleset>

<rule id=“ck81”>

<address>

<FETCHER>Shenzhen </FETCHER>

</address>

</rule>

</ruleset>

2) Addition of an Item to a Display Condition Information XML File

PUT
http://xcap.example.com/services/sip:yangzhao@example.com/friends.xml/˜˜/rul
eset/rule[@id=“ck81”]/SUBSCRIBER HTTP/1.1

...

Content-Type: application/xml
Content-Length: (...)
<?xml version-“1.0” encoding=“UTF-8”?>
<SUBSCRIBER>

Huawei Technologies, Shenzhen

</SUBSCRIBER>

Therefore, the presence server may provide a corresponding value for the same presence information of the presentity to a watcher according to a type of the watcher (the types of the watcher include FETCHER and SUBSCRIBER). In other words, the attribute of the watcher herein is whether the watcher is in the buddies list of the presentity,

The above method wherein the value of the information is directly written into a XML file for display condition information specifically suits static information, such as address, age. However, for dynamic information, such as online status, mood, a separating mode is preferred, wherein authorization policy (such as common policy) and classification of the presence information are combined. In other words, the authentication policy is set by the presentity for the presence server to indicate which watcher can obtain which type of presence information. The identification of the watcher or the field may be associated with a class identification, and in the presence information distributed by the presentity to the presence server, the same presence information element may be set with a plurality of values simultaneously each associated with a corresponding class identification. When the presence server distributes the presence information to the watcher according to the authorization policy, the corresponding value of the presence information sent to the watcher can be determined based on an association relation established from the above class identification. Generally for a non-buddy watcher, the presentity can set a default rule, and if the presentity desires to provide a specific value of the presence information to the watcher, it needs to set a corresponding class identification in the default rule. In this way, the authorization policy needs to distribute the corresponding class identification for the value of the presence information, rather than change frequently according to the presence information.

In practical application scenes, if a stranger obtains the identification of the presentity through conditional inquiry, chat room, or blog and so on, when he or she requests the presence information of the presentity, some simple information will be provided to him or her. If the stranger is authenticated as a buddy, more information will be distributed to him or her. Thus, the privacy of the user is sufficiently guaranteed.

It is also possible to establish a mapping relation table between the watcher's attribute and the value for presence information in a memory of the presence server or a peripheral storage medium so as to set values corresponding to the watchers' attributes respectively for the same presence information provided by a presentity. Thus, the presence server may retrieve the mapping relation table according to the watcher's attributes and obtain corresponding values of presence information; then the corresponding values of presence information obtained are provided to the watcher, so different values of presence information may be provided by the presentity according to different watchers' attributes.

For example, it is very convenient to store display condition condition information using database records. If the presence server stores presence information and displays condition information in a way of database, display condition information may be set using the following table so as to provide corresponding values of presence information to watchers having different presence information,

| | PRESENCE | PRESENCE | VALUE FOR | VALUE FOR PRESENCE |
|---|---|---|---|---|
| | INFORMATION | INFORMATION | PRESENCE | INFORMATION |
| USER | IDENTIFICATION | IDENTIFICATION | INFORMATION | OF THE WATCHER |
| IDENTIFICATION | OF THE PRESENTITY | OF THE WATCHER | OF THE WATCHER | PRESENTITY |
| 106035 | Weather | CITY | GUANGZHOU | Clear to cloudy |
| 106035 | Weather | CITY | SHENZHEN | Shower with |
| | | | | gale |

The above table includes a user identification, a presence information identification of the presentity, a presence information identification of the watcher, a value for presence information of the watcher, a value for presence information of the presentity. Display condition information thus set may use “presence information identification of the watcher—value for presence information of the watcher” as an retrieving condition, so as to provide “presence information identification of the presentity—value for presence information of the presentity” corresponding to the user identification to the watcher. If the field “value for presence information of the watcher” in the above table is changed to “watcher type”, then corresponding values of presence information may be provided according to different watcher types. In this embodiment, the watcher's attribute is presence information provided by the watcher.

To provide corresponding values of presence information to watchers of different groups, the table may be set to include fields of a user identification, presence information identification of the presentity, watcher group, a value for presence information of the presentity and so on. The value of the field “watcher group” may be a group identification set by the presentity, and may also be a user identification of the watcher. Additionally, the presence server usually determines the watcher group according to the correspondence record between the watcher and the presentity group. The correspondence record is preset and saved in the presence server, and includes a user identification of the presentity, a user identification of the watcher and an identification of the watcher group. Taking the setting of display condition information of presence information, such as “address”, of the presentity with user identification 4985555 as an example, the table will be set as follows:

| | PRESENCE | | |
|---|---|---|---|
| | INFORMATION | | VALUE FOR PRESENCE |
| USER | IDENTIFICATION | WATCHER | INFORMATION OF THE |
| IDENTIFICATION | OF THE PRESENTITY | GROUP | PRESENTITY |
| 4985555 | ADDRESS | FRIEND | HUAWEI TECHNOLOGIES, |
| | | | SHENZHEN |
| 4985555 | ADDRESS | STRANGER | SHENZHEN |
| 4985555 | ADDRESS | BLACKLIST | THE EARTH |
| 4985555 | ADDRESS | 4488889 | HUAWEI BASE, BANTIAN, |
| | | | LONGGANG DISTRICT, |
| | | | SHENZHEN, F1-07-A077S |
| 4985555 | ADDRESS | DEFAULT | SHENZHEN |

The above display condition information may be set in advance, or may be set when a watcher sends a subscription request.

The display condition information is set when adding a buddy or being added as a buddy (i.e. subscribing to presence information or presence information being subscribed). The second presence client terminal may send a request to the presence server for adding the first presence client terminal as a buddy or a contact person, i.e. the second presence client terminal may subscribe to the presence information of the first presence client terminal. The presence server sends the request to the first presence client terminal for confirmation. If the first presence client terminal returns a rejection message, then the presence server sends the rejection message to the second presence client terminal and informs the second presence client terminal that the second presence client terminal cannot subscribe to the presence information; if the first presence client terminal allows the request, then the value for presence information to be provided to the second presence client terminal may be further set, and a setting interface is displayed to the first presence client terminal, which includes presence information identifications and respective values of presence information corresponding thereto. The corresponding values of presence information may be modified, and the default value for presence information is displayed initially. The corresponding relations between the values of presence information that are set and the watcher's attributes, together with the Subscription Permitted Message returned by the first presence client terminal, is submitted to the presence server after user's modification. The corresponding display condition information record is added to a database on the presence server. For example, if the value of “address” in the presence information displayed to a user with user identification 4488889 and set by a user with user identification 4985555 is “HUAWEI BASE, Bantian, Longgang District, Shenzhen, F1-07-A077S”, then the value of “age” is “24”, and the values of other presence information are default values. The record added is:

| | PRESENCE | | |
|---|---|---|---|
| | INFORMATION | | VALUE FOR PRESENCE |
| USER | IDENTIFICATION | WATCHER | INFORMATION OF THE |
| IDENTIFICATION | OF THE PRESENTITY | GROUP | PRESENTITY |
| 4985555 | ADDRESS | 4488889 | HUAWEI BASE, BANTIAN, |
| | | | LONGGANG DISTRICT, |
| | | | SHENZHEN, F1-07-A077S |
| 4985555 | AGE | 4488889 | 24 |

In this embodiment, the watcher's attribute is the group identification information of the watcher set by the presentity.

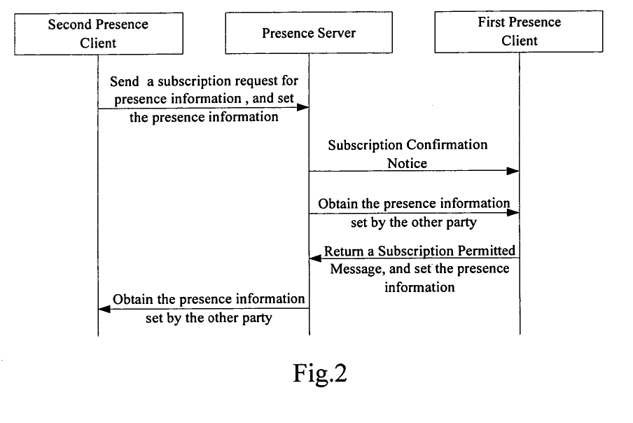

When the second presence client terminal sends a request to the presence server for adding the first presence client terminal as a buddy or a contact person, the value for presence information to be provided to the first presence client terminal may also be set simultaneously, and the correspondence between the value for presence information and the attribute of the presentity, together with a Subscription Request Message, may be sent to the presence server. The presence server may temporarily cache the value for presence information set by the second presence client terminal. If the first presence client terminal returns a Subscription Rejected Message, the presence server deletes the cached correspondence between the value for presence information and the attribute of the presentity; if the first presence client terminal returns a Subscription Permitted Message, the presence server saves the correspondence between the value for presence information set by the second presence client terminal and the attribute of the presentity in a database. Thus, for a natural person user, the values of presence information to be provided to another party may be set when another user is added as a buddy or contact person or when the natural person user himself/herself is added as a buddy or contact person. The details of this process may be referred to FIG. 2.

Now, a detailed implementation process in which the first presence client terminal releases presence information and sets display condition information will be described in detail taking a natural person as an example.

1) The First Presence Client Terminal Releases Presence Information:

When a user registers initially, each default value for presence information may be set and released. The presence information of the first presence client terminal includes basic information and state information; the basic information of a natural person may include personal family information, contact information, nationality, gender, birthday and so on; State information is adapted to display the current state of the first presence client terminal, which includes logon, online, being away, in conference, or answering a phone, etc. The presence information list of the first presence client terminal is shown in the following table:

| | | |
|---|---|---|
| BASIC | PERSONAL | NAME, NICKNAME, |
| INFORMATION | INFORMATION | GENDER, AGE, |
| | | MARITAL STATUS, |
| | | PROFESSION, BODY |
| | | HEIGHT, BODY WEIGHT |
| | FAMILY | FAMILY MEMBERS, |
| | INFORMATION | HOME ADDRESS |
| | CONTACT | MOBILE PHONE |
| | INFORMATION | NUMBER, HOME PHONE, |
| | | E-MAIL |
| | ADDRESS | STATE (REGION), |
| | INFORMATION | PROVINCE/MUNICIPALITY, |
| | | ZIP CODE, TIME ZONE |
| | CONTACT | FAMILY MEMBER, FRIEND, |
| | PERSON | COLLEAGUE, STRANGER, |
| | | BLACKLIST |

| | |
|---|---|
| STATE INFORMATION | ONLINE, BEING AWAY, |
| | IN CONFERENCE, |
| | ANSWERING A PHONE, |
| | TEXT INFORMATION |
| | INPUT FREELY, |
| | LOCATION INFORMATION, |
| | ETC |

2) The First Presence Client Terminal Sets the Display Condition Information of the Presence Information:

The display condition information set by the first presence client terminal is the display condition of the content of the presence information which the first presence client terminal wants to be seen by its buddy or contact person, in other words, the value of same presence information which the first presence client terminal wants to be seen by other different presence client terminals (i.e., contact persons) may be different. The first presence client terminal may also modify the presence information which has been set for a certain buddy or contact person, and then release the presence information.

The first presence client terminal sets presence information according to groups:

Usually, users will divide their buddies or contact persons into several groups. Some systems, such as QQ, provide default groups of Friend, Stranger, Blacklist and so on. Therefore, it will be more convenient to set different values for respective groups for the same presence information. A global default value may be further set for the same presence information, then a group default value may be set for each group, and finally corresponding values of presence information may be set respectively for individual contact persons in each group. In order to reduce data redundancy, a table may be established for global default values of presence information of the user, a table may be established for group default values of the user, and a table may be established for values of presence information set for individual contact persons. Thus, when the presence server provides the presence information of a user to other user, the presence server first retrieves the other user in the presence information table set for individual contact persons, if found, then provide the corresponding value for presence information; if not found, then continues to search the default value table of each group for the value for presence information set for the group to which the other user belongs, if found, then provides the corresponding value for presence information, otherwise, provides the presence information in the global default value table directly.

Thus, for the same presence information set by the first presence client terminal, different values may be displayed to different contact persons in same group. For example, it is assumed that contact persons in group “Colleague” include Jenny and Alex, and for the different contact persons Jenny and Alex in same group, the display condition information set by the first presence client terminal for the same presence information such as “Nickname” is to display “Rose” and “Mary” respectively, as a result, when Jenny and Alex both subscribe to the same presence information “nickname” of the first presence client terminal, the nickname of the first presence client terminal provided to Jenny by the presence server will be “Rose”, while the nickname of the first presence client terminal provided to Alex, who belongs to the same group as Jenny, will be “Mary”.

In order to minimize the modifications on present instant communication systems such as MSN and QQ, especially on the database structure or the XML file structure and so on, the following technical solution may be employed: the original value for presence information is changed to a conditional expression, which indicates different values for different conditions, rather than one value; for example, the conditional expression corresponding to presence information “address” is: “group=friend: Huawei Technologies, Shenzhen & group=stranger: Shenzhen”, which means that when group=Friend, the value for presence information “Address” to be provided will be “Huawei Technologies, Shenzhen”, and when group=Stranger, the value for presence information “Address” to be provided will be “Shenzhen”. The presence server obtains corresponding values of presence information by resolving the conditional expression, and provides the corresponding values of presence information to a watcher.

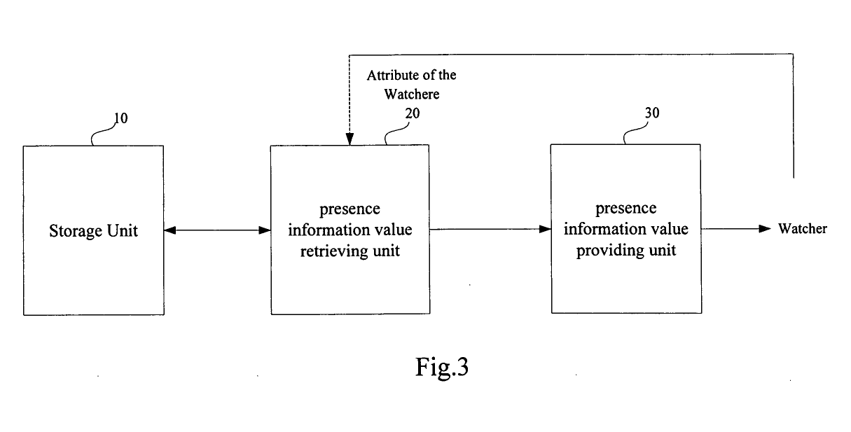

Corresponding to the above first method for providing presence information according to an embodiment of the invention, a presence server will be further provided, which is shown in FIG. 3 as a block diagram of the first presence server provided according to the invention. The first presence server mainly includes: a storage unit 10, a presence information value retrieving unit 20 and a presence information value providing unit 30. The functions of the above units are as follows:

the storage unit 10 is adapted to store values corresponding to the watchers' attributes respectively for the same presence information provided by a presentity;

the presence information value retrieving unit 20 is adapted to retrieve a value for presence information corresponding to the watcher's attribute among the values corresponding to the watchers' attributes respectively for the same presence information stored in the storage unit 10, according to the corresponding attribute of the watcher; and

the presence information value providing unit 30 is adapted to provide the corresponding value for presence information retrieved by presence information retrieving unit 20 to the watcher.

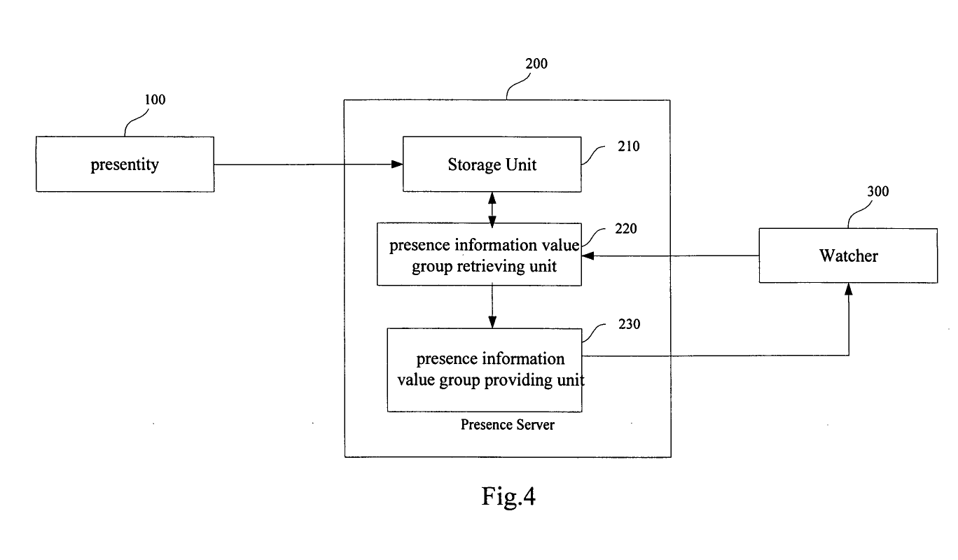

Corresponding to the above first method for providing presence information according to an embodiment of the invention, a system for providing presence information will be further provided, as shown in FIG. 4, a block diagram of the first system for providing presence information provided according to an embodiment of the invention. The first system for providing presence information mainly includes: a presentity 100, a presence server 200 and a watcher 300. The presence server 200 specifically includes a storage unit 210, a presence information value retrieving unit 220 and a presence information value providing unit 230, specifically:

the presentity 100 is adapted to provide values corresponding to the watchers' attributes respectively for the same presence information to the presence server 200;

the watcher 300 is adapted to send a subscription request for presence information to the presence server 200;

the presence server 200 is adapted to store values corresponding to the watchers' attributes respectively for the same presence information provided by presentity 100, and retrieving a value for presence information corresponding to watcher 300 among the stored values corresponding to the watchers' attributes respectively for the same presence information according to the watcher's attribute and providing the value for presence information to the watcher 300 when the subscription request for presence information sent by watcher 300 is received, specifically, in presence server 200:

the storage unit 210 is adapted to store the values corresponding to the different watchers' attributes respectively for the same presence information provided by presentity 100;

the presence information value retrieving unit 220 is adapted to retrieve the value for presence information corresponding to the watcher's attribute among the values corresponding to the different watchers' attributes respectively for the same presence information stored in the storage unit 210, according to the watcher's attribute;

the presence information value providing unit 230 is adapted to provide the value for presence information corresponding to the watcher's attribute retrieved by the presence information retrieving unit 220 to the watcher.

For details about related technologies of the first presence server and the system for providing presence information of an embodiment of the invention, reference may be made to the detailed description of related technologies of the first method for providing presence information according to an embodiment of the invention, so they will not be described again.

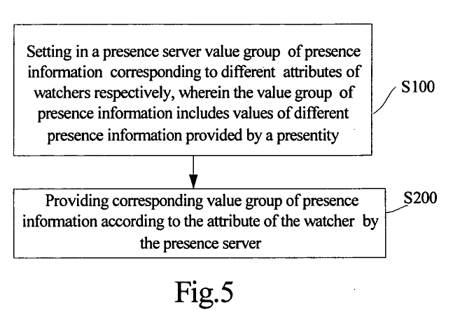

Correspondingly, an embodiment of the invention provides another method for providing presence information, and the main principle of the method is shown in FIG. 5, the main implementation processes of method are as follows:

Block S100: setting value groups of presence information corresponding to the watchers' attributes respectively in a presence server, wherein the value group of presence information includes corresponding values of different presence information provided by a presentity;

Block S200: Subsequently, providing, by the presence server, corresponding value group of presence information according to the watcher's attributes.

In the above Block S100, default value group of presence information may also be set in the presence server, the default value group of presence information including default values of different presence information provided by the presentity. Subsequently, when the presence server cannot obtain the value group of presence information, the default value group of presence information will be provided to the watcher.

Similarly, the above mentioned attribute of the watcher may be the presence information provided by the watcher, and the presence information provided by the watcher may be basic information of the watcher (static information such as region information, gender information, age information provided by the watcher), or the state information of the watcher (dynamic information such as online, offline, mood). The above mentioned attribute of the watcher may also be information set by the presentity for the watcher, which may be a group identification information of the watcher set by the presentity, etc. The above mentioned attribute of the watcher may also be the type of the watcher, including Subscriber and Fetcher. Additionally, the above mentioned attribute of the watcher may also be the identification of the watcher, such as watcher user ID. Correspondingly, a combination of at least two of any types of the above attribute information such as the presence information provided by the watcher, the information set by the presentity for the watcher, the type of the watcher and the identification of the watcher, may also be regarded as the attribute information of the watcher.

In various application scenes, a corresponding attribute of the watcher may be used for setting. Different presence information is distributed to different buddy groups of the presentity. For example, the presence information set for a family group is different from the presence information set for a colleague group. In addition, it is also useful that the corresponding presence information is provided based on the presence information provided by the watcher. For example, the presence information related to a position of the watcher is provided based on the position information of the watcher. Further, if the watcher is in busy or offline status, no presence information or the simplest presence information such as online status will be provided. In this way it is not necessary to provide the presence information to the watcher when the watcher is in busy or offline status Even if the watcher is in offline status because the watcher is set as invisible mode, based on a peer rule of information provision, the presentity can provide the least information to the watcher. Certainly, the presence server of the presentity needs to obtain current presence information of the watcher from the presence server of the watcher, and if the presence server of the presentity and the presence server of the watcher are identical or in an identical domain, the current presence information of the watcher can be obtained easily; if they are not in an identical field, because the subscription is actually mutual, when the watcher initiates the subscription, the presence server of the presentity can initiatively refresh the subscription for the watcher to obtain the presence information of the watcher, and hereby determines the presence information to be returned to the watcher.

Moreover, corresponding value groups of presence information may also be set respectively for different watchers' attributes in a presence server. Usually, a value group of presence information may include all or part of the corresponding values of presence information provided by a presentity. For two values of presence information groups corresponding to two different watchers' attributes respectively provided by a presentity, at least one of the values of presence information is different. The presence server provides a corresponding value group of presence information to a watcher according to the watcher's attribute. Taking the situation in which the watcher's attribute is the group identification of the watcher set by the presentity as an example, the technical solution of an embodiment of the invention will now be illustrated.

It is assumed that two groups “Colleague” and “Network Friend” are set by the presentity, and a corresponding value group of presence information is set for the group “Colleague” in a presence server, which includes a value for presence information “HUAWEI BASE, Bantian, Longgang District, Shenzhen, F1-07-A077S” with presence information identification “address” provided by the presentity, and a value for presence information “24” with presence information identification “age” provided by the presentity; the correspondence between the watcher group “Colleague” and the corresponding value group of presence information is shown in the following table:

| | PRESENCE | |
|---|---|---|
| | INFORMATION | |
| | IDENTIFICATION | VALUE FOR PRESENCE |
| WATCHER | OF THE | INFORMATION OF THE |
| GROUP | PRESENTITY | PRESENTITY |
| COLLEAGUE | ADDRESS | HUAWEI BASE, |
| | | BANTIAN, LONGGANG |
| | | DISTRICT, SHENZHEN, |
| | | F1-07-A077S |
| | AGE | 24 |

In addition, at the same time, for the watcher group “Network Friend”, another corresponding value group of presence information is set, which includes a value for presence information “Longgang, Shenzhen” with presence information identification “address” provided by the presentity, and a value for presence information “0” with presence information identification “age” provided by the presentity; the correspondence between the watcher group “Network Friend” and the corresponding value group of presence information is shown in the following table:

| | PRESENCE | |
|---|---|---|
| | INFORMATION | |
| | IDENTIFICATION | VALUE FOR PRESENCE |
| WATCHER | OF THE | INFORMATION OF THE |
| GROUP | PRESENTITY | PRESENTITY |
| NETWORK | ADDRESS | LONGGANG DISTRICT, |
| FRIEND | | SHENZHEN |
| | AGE | 20 |

Thus, a value group of presence information for displaying “address: HUAWEI BASE, Bantian, Longgang District, Shenzhen, F1-07-A077S & age: 24” will be provided to contact persons in group “Colleague” by the presence server; while a value group of presence information for displaying “address: Longgang, Shenzhen & age: 20” will be provided to contact persons in group “Network Friend”.

In addition, a default value group of presence information may also be set correspondingly in the presence server, which is shown in the following table:

| | PRESENCE | |
|---|---|---|
| | INFORMATION | |
| | IDENTIFICATION | VALUE FOR PRESENCE |
| WATCHER | OF THE | INFORMATION OF THE |
| GROUP | PRESENTITY | PRESENTITY |
| DEFAULT | ADDRESS | SHENZHEN |
| | AGE | 0 |

Thus, if the presence server cannot retrieve the corresponding value group of presence information according to the watcher's attribute, the presence server may provide the default value group of presence information to the watcher directly. For instance, in the above example, if a watcher belongs to neither group “Network Friend” nor group “Colleague”, the values of presence information in the default value group will be provided to the watcher. A default value group usually includes the default values of all the presence information. When no corresponding values of presence information exist in other value groups of presence information, the default values of corresponding presence information in the default value group will be provided. As in the above example, no corresponding values of all the presence information except Address and Age, such as Nickname, Gender, are set in group “Colleague” and group “Network Friend”, thus, corresponding default values of presence information such as Nickname, Gender set in the default value group will be provided.

Certainly, in a presence server, value groups of presence information including multiple presence information provided by a presentity may be set respectively corresponding to the watchers' attributes. For example, a value group of presence information corresponding the watcher's attribute may include 3, 4, . . . n or all corresponding values of presence information provided by a presentity; subsequently, the presence server may retrieve all of the corresponding values of presence information related to the watcher directly in a single process, according to the watcher's attribute.

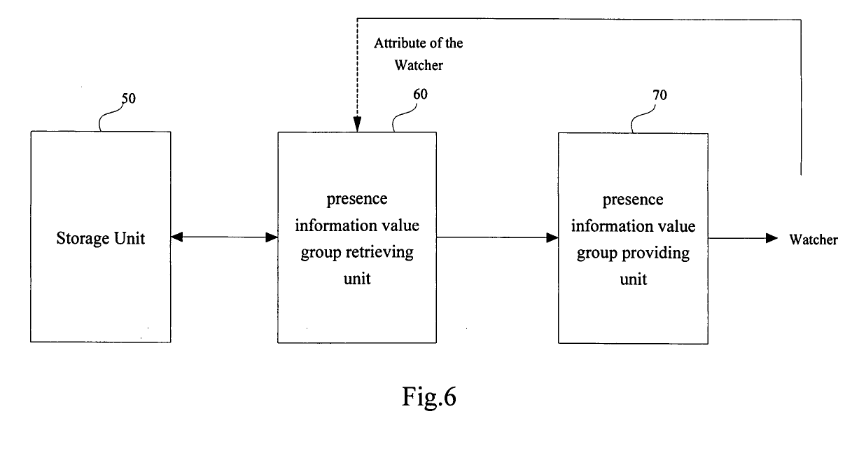

Corresponding to the above second method for providing presence information, a presence server will be further provided, as shown in FIG. 6, which is a block diagram of the second presence server provided according to an embodiment of the invention. The second presence server mainly includes a storage unit 50, a presence information value group retrieving unit 60 and a presence information value group providing unit 70. The functions of the above units are as follows:

The storage unit 50 is adapted to store the corresponding relations between different watchers' attributes and corresponding value groups of presence information, the value group of presence information including corresponding values of different presence information provided by a presentity;

the presence information value group retrieving unit 60 is adapted to retrieve a value group of presence information corresponding to the watcher's attribute in the corresponding relations between different watchers' attributes and corresponding value groups of presence information stored in the storage unit 50, according to the watcher's attribute; and

the presence information value group providing unit 70 is adapted to provide the value group of presence information retrieved by the presence information value group retrieving unit 60 to the watcher.

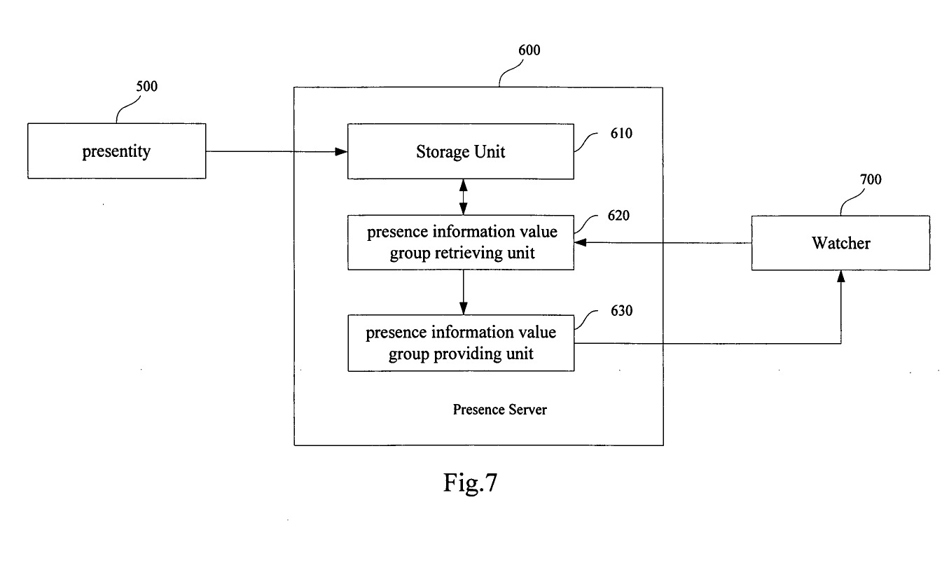

Corresponding to the above second method for providing presence information, a system for providing presence information will be further provided, as shown in FIG. 7, which is a block diagram of the second system for providing presence information provided according to an embodiment of the invention. The second system for providing presence information mainly includes a presentity 500, a presence server 600 and a watcher 700. The presence server 600 includes a storage unit 610, a presence information value group retrieving unit 620 and a presence information value group providing unit 630. Specifically,

the presentity 500 is adapted to provide value groups of presence information corresponding to the watchers' attributes to the presence server 600, each value group of presence information including corresponding values of different presence information provided by the presentity 500;

the watcher 700 is adapted to send a subscription request for presence information to the presence server 600;

the presence server 600 is adapted to store the corresponding relations between different watchers' attributes and corresponding value groups of presence information according to the value groups of presence information corresponding to the different watchers' attributes provided by presentity 500, and retrieving a value group of presence information corresponding to an attribute of the watcher 700 in the stored corresponding relations between the watchers' attributes and the value groups of presence information according to the watcher's attribute 700 and providing the retrieved value group of presence information to the watcher 700 when the subscription request for presence information from watcher 700 is received; specifically, in the presence server 600,

the storage unit 610 is adapted to store the corresponding relations between different watchers' attributes and corresponding value groups of presence information;

the presence information value group retrieving unit 620 is adapted to retrieve a value group of presence information corresponding to the watcher's attribute in the corresponding relations between different watchers' attributes and corresponding value groups of presence information stored in storage unit 610, according to the watcher's attribute; and

the presence information value group providing unit 630 is adapted to provide the value group of presence information retrieved by presence information value group retrieving unit 620 to the watcher 700.

The attributes of the watcher may also include whether the watcher is communicating with the presentity, for example whether the watcher is performing instant message session communication or voice video session communication with the presentity. For a watcher in communication with the presentity, the presentity generally can provide more information to the watcher. For example, if the presentity is set as offline or invisible, the state of the presentity appears offline or close for the watcher who does not communicate with the presentity, and some other presence information such as mood, activities cannot be provided to the watcher. However, if the presentity in invisible state initiatively starts up and establishes a communication session with one watcher, the presentity will set a corresponding authorization rule for the watcher, and then the presence server will provide an online state and other presence information to the watcher.

In another example, when the presentity is communicating with the watcher, for example, one chat window is started up for text chat. At the same time the client terminal of the presentity is playing music, and the music information can be distributed to the presence server as presence information, for example, basic information such as title of the music, singer, and special, and play start time of the music, resource address of the music. For a general watcher, the title of the music can be seen, and many instant message tools of prior art supports the feature. However, for the watcher in communication with the presentity, the presence server can also provide the play start time, the resource address of the music and so on to the watcher in communication with the presentity, and then the watcher displays lyrics of the music or plays the music synchronously in the chat window of the watcher according to the play start time. The synchronization can be realized as follows: a client terminal of the watcher performs inquiry locally or on a network to obtain a lyric file according to the obtained basic information such as the title of the music, wherein, the lyric file is usually in LRC format and includes each sentence of the lyric and a time offset corresponding to the sentence; a play duration of the music is obtained by comparing the obtained play start time of the music with a local time; then the lyric is synchronously displayed so that the watcher can synchronously view the lyric of the played music of the presentity. In addition, local inquiry or on inquiry on a network can be performed to obtain a music data file. such as file in MP3 format according to basic information of the music or a resource address and so on, and then in the same way the music file can be played synchronously according to a play duration calculated on the client terminal of the watcher. Similarly, for a video such as camera, teleplay or short film editing, the watcher can synchronously display a caption or play a video file. Thus communication contents are enriched so that it is possible to enjoy same music and video and so on conveniently and synchronously between buddies in communication.

Obviously, those skilled in the art can make various amendments and modifications on the embodiments of the invention without departing from the spirit or scope of the invention. Thus, if these amendments and modifications fall into the scope of the appended claims and its equivalents, the invention is intended to include them.

1. A method for providing presence information, comprising:
setting values of one piece of presence information provided by a presentity in a presence server corresponding to watchers' attributes respectively; and
providing a corresponding value of presence information according to a watcher's attribute by a presence server.

2. The method according to claim 1, wherein before providing the corresponding value of the presence information according to the watcher's attribute, the method further comprises setting a default value of the presence information provided by the presentity in the presence server; and
providing the corresponding value of presence information according to the watcher's attribute comprises providing the default value for presence information to a watcher when the presence server cannot obtain a value of the presence information corresponding to the watcher's attribute.

3. The method according to claim 1, wherein before setting the values of the presence information provided by the presentity in the presence server corresponding to the watchers' attributes respectively, the method further comprises:
setting, when the presentity receives a subscription request from the watcher, the value of the presence information provided by the presentity corresponding to the watcher's attribute by the presentity; and
sending a corresponding relation between the value set by the presentity and the watchers' attribute, together with a Subscription Permitted Message, to the presence server.

4. The method according to claim 3, wherein, before setting the value of the presence information provided by the presentity corresponding to the watcher's attribute, the method further comprises:
setting the value of the presence information provided by the watcher corresponding to the presentity's attribute when the watcher requests subscribing to the presence information of the presentity;
sending a corresponding relation between the value of the presence information set by the watcher and the presentity's attribute, together with a Subscription Request Message, to the presence server;
buffering the corresponding relation between the value of the presence information set by the watcher and the presentity's attribute and forwarding the Subscription Request Message to the presentity by the presence server;
providing corresponding value of the presence information to the presentity by the presence server if the presentity feeds back a Subscription Permitted Message to the presence server in response to the Subscription Request Message received; and
deleting the buffered corresponding relation between the value of the presence information set by the watcher and the presentity's attribute by the presence server if the presentity feeds back a Subscription Rejected Message to the presence server.

5. The method according to claim 1, wherein:
setting the values of the presence information provided by the presentity in the presence server corresponding to the watchers' attributes respectively comprises establishing an expression of corresponding relations between the watchers' attributes and the values of the presence information in the presence server; and
providing the value of the presence information according to the watcher's attribute comprises:
resolving the expression of the corresponding relation according to the watcher's attribute and obtaining corresponding value of the presence information by the presence server; and
providing the corresponding value of the presence information obtained to the watcher.

6. The method according to claim 1, wherein:
setting the values of the presence information provided by the presentity in the presence server corresponding to the watchers' attributes respectively comprises establishing a mapping relation table between the watchers' attributes and the values of the presence information in a memory of the presence server or a peripheral storage medium; and
providing the corresponding value of the presence information according to the watcher's attribute comprises:
retrieving the mapping relation table according to the watcher's attribute and obtaining corresponding value of presence information by the presence server; and
providing the corresponding value of the presence information obtained to the watcher.

7. The method according to claim 1, wherein the watcher's attribute is:
presence information of the watcher;
information set by the presentity for the watcher;
a type of the watcher;
an identification of the watcher; or
a combination of at least two of any types of the presence information of the watcher, the information set by the presentity for the watcher, the type of the watcher and the identification of the watcher.

8. The method according to claim 7, wherein the presence information of the watcher is one type of basic information of the watcher and state information of the watcher.

9. The method according to claim 7, wherein the set information is a group identification of the watcher set by the presentity.

10. The method according to claim 7, wherein the type of the watcher is SUBSCRIBER, or FETCHER.

11. The method according to claim 1, wherein the watcher's attribute is whether there is a communication session between the presentity and the watcher,
If there is a communication session between the presentity and the watcher, and the presentity distributes music and video information, the presence server provides a play start time of a music or video to the watcher, the watcher plays the music or video according to the play start time, or displays lyrics or caption corresponding to the music or video.

12. The method according to claim 1, wherein, the watcher's attribute is whether there is a communication session between the presentity and the watcher,
If there is a communication session between the presentity and the watcher and the presentity is under an invisible state, the presence server provides normal presence information under visible state to the watcher.

13. A presence server, comprising:
a storage unit, adapted to store values of one piece of presence information provided by a presentity corresponding to watchers' attributes respectively;
a presence information value retrieving unit, adapted to retrieve a corresponding value among the values of the presence information corresponding to the different watchers' attributes respectively stored in the storage unit, according to a watcher's attribute; and
a presence information value providing unit, adapted to provide the corresponding value retrieved by the presence information value retrieving unit to the watcher.

14. A system for providing presence information, comprising a presentity, a presence server and a watcher, wherein:
the presentity is adapted to provide values of one piece of presence information corresponding to the watchers' attributes respectively to the presence server;
the watcher is adapted to send a subscription request for the presence information to the presence server; and
the presence server is adapted to store the values of the presence information corresponding to the different watchers' attributes respectively provided by the presentity, and retrieving a corresponding value among the stored values of the same presence information corresponding to the different watchers' attributes respectively according to an attribute of a watcher and providing the retrieved corresponding value to the watcher when receiving a subscription request for the presence information from the watcher.

15. The system according to claim 14, wherein the presence server comprises:
a storage unit, adapted to store the values of the presence information provided by the presentity corresponding to watchers' attributes respectively;
a presence information value retrieving unit, adapted to retrieve a corresponding value among the values of the presence information corresponding to the different watchers' attributes respectively stored in the storage unit, according to a watcher's attribute; and
a presence information value providing unit, adapted to provide the corresponding value retrieved by the presence information value retrieving unit to the watcher.

16. A method for providing presence information, comprising:
setting corresponding value groups of presence information respectively for different watchers' attributes in a presence server, wherein the value group of presence information comprises values of different presence information provided by a presentity; and
providing a corresponding value group of presence information according to a watcher's attribute by the presence server.

17. The method according to claim 16, wherein:
setting the corresponding value groups for the presence information respectively for the different watchers' attributes in the presence server further comprises setting a default value group of presence information in the presence server, wherein the default value group of the presence information comprises default values of different presence information provided by the presentity; and
providing the corresponding value groups of the presence information according to the watcher's attribute further comprises providing the default value group of the presence information to the watcher when the presence server cannot obtain the corresponding value group of the presence information.

18. The method according to claim 16, wherein the watcher's attribute is:
presence information of the watcher;
information set by the presentity for the watcher;
a type of the watcher;
an identification of the watcher; or
a combination of at least two of any types of the presence information of the watcher, the information set by the presentity for the watcher, the type of the watcher and the identification of the watcher.

19. A presence server, comprising:
a storage unit, adapted to store corresponding relations between different watchers' attributes and corresponding value groups of presence information, wherein the value group of presence information comprises values of different presence information provided by a presentity;
a presence information value group retrieving unit, adapted to retrieve a corresponding value group of presence information in the corresponding relations between the different watchers' attributes and the corresponding value groups of presence information stored in the storage unit, according to a watcher' attribute; and
a presence information value group providing unit, adapted to provide the value group of presence information retrieved by the presence information value group retrieving unit to the watcher.

20. A system for providing presence information, comprising a presentity, a presence server and a watcher, wherein:
the presentity is adapted to provide value groups of presence information corresponding to the watchers' attributes to the presence server, wherein the value groups of the presence information comprise corresponding values of different presence information provided by a presentity;
the watcher is adapted to send a subscription request for the presence information to the presence server; and
the presence server is adapted to store corresponding relations between the watchers' attributes and the corresponding value groups of presence information according to the value groups of the presence information which correspond to the watchers' attributes provided by the presentity, and retrieving a corresponding value group of presence information in the stored corresponding relations between the watchers' attributes and the value groups of the presence information according to a watcher's attribute and providing the retrieved corresponding value group to the watcher, when receiving a subscription request for the presence information from the watcher.

21. The system according to claim 20, wherein the presence server comprises:
a storage unit, for storing the corresponding relations between the different watchers' attributes and the corresponding value groups of presence information;
a presence information value group retrieving unit, for retrieving the corresponding value group of presence information in the corresponding relations between the different watchers' attributes and the corresponding value groups of presence information stored in the storage unit, according to the watcher's attribute; and
a presence information value group providing unit, for providing the value group of presence information retrieved by the presence information value group retrieving unit to the watcher.
